(19) United States
(12) Patent Application Publication
(10) Pub. No.: US 2025/0327756 A1
(43) Pub. Date: Oct. 23, 2025

(54) DEVICE, SYSTEM AND METHOD FOR INSPECTING THREE-DIMENSIONAL OBJECTS

(71) Applicant: ISRA VISION GmbH, Darmstadt (DE)

(72) Inventors: Jens HÜLSMANN, Hagen (DE); Daniel HEGELS, Dortmund (DE); Thomas ZIMMERMANN, Haltern am See (DE)

(21) Appl. No.: 19/181,886

(22) Filed: Apr. 17, 2025

(30) Foreign Application Priority Data
Apr. 19, 2024 (DE) 10 2024 110 990.4
Apr. 19, 2024 (DE) 10 2024 110 992.0

(51) Int. Cl. G01N 21/88; G01N 21/95

(52) U.S. Cl. CPC G01N 21/8806; G01N 21/95; G01N 2021/8854

(57) ABSTRACT

A device and method for inspecting three-dimensional objects, wherein each object includes an upper surface section and a plurality of lateral surface sections. The device includes: a motion detection unit, a line lighting unit for illuminating a line-shaped area of the top side of the object to be inspected, an area lighting unit, and a matrix camera arranged above the rest state position of the respective object. The field of view is configured for line-by-line capturing of the line lighting unit's light reflected by the line-shaped area of the top side in the motion state of the object to be inspected and for matrix-wise capturing of the area lighting unit's light reflected upwards from the entire top side in the rest state of the object to be inspected. Also, a data processing unit is provided which determines the presence of a defect of at least one defect type from the captured image data and/or determines a quality score.

### CROSS-REFERENCE TO RELATED APPLICATIONS

This application claims priority to German Patent Application No. DE 10 2024 110 990.4 filed Apr. 19, 2024 and to German Patent Application No. DE 10 2024 110 992.0 filed Apr. 19, 2024, both of which are incorporated herein in their entirety.

### TECHNICAL FIELD

The invention relates to a device that is suitable for inspecting three-dimensional objects, in particular so-called pouch battery cells (hereinafter referred to as pouch cells), and a corresponding method.

### BACKGROUND

Pouch cells are a type of battery that is used in particular for lithium-ion batteries. A pouch cell usually consists of a pouch-like housing or packaging formed by a plastic-coated metal foil (e.g. aluminium foil). This type of cell is therefore also referred to as a polymer battery. The housing is designed as a flexible, flat and lightweight pouch or cushion sealed to the outside. Inside the housing, there is usually a stack of superimposed electrode layers, active layers and separator layers. The terminals are formed as two tabs that protrude from the pouch-like housing adjacently on one side, on adjacent sides or on opposite sides. Pouch cells are known for their high energy density, compact design and flexibility, making them suitable for various applications, including electric vehicles. Pouch cells can be easily resized to meet the specific requirements of different electric vehicle models. Their flat and flexible design also allows for easier integration into different vehicle spaces, resulting in more efficient packaging and improved use of space. A disadvantage of the pouch cell design is that, due to their construction, they are generally sensitive to mechanical damage. This may easily cause the release of gases or electrolyte, or it may cause the cells to swell up considerably or cause internal short circuits.

It is therefore desirable to inspect such and other three-dimensional objects thoroughly during quality control to detect damaged objects at an early stage.

Various options for quality control of flat objects such as battery cells have already been disclosed. For example, a method is known from document US 2022/0 390 387 A1 in which optical coherence tomography (OCT) is used to inspect a gap between a lead foil and a tab of a pouch cell. This may provide information about the quality of the pouch cell seal, but this has very limited significance for the quality of the pouch cell. Document EP 4 117 081 A1 describes a very complex inspection system comprising a thickness measuring unit, a unit for measuring electrical properties, a printing unit, a tab cutting unit, a weighing unit, a tab testing unit and a defect selection unit. The thickness measuring unit measures the thickness of the pouch cell and the printing unit is used to print information about the pouch cell on its surface. The tab inspection unit determines the length and shape of the tab using vision inspection. Defective pouch cells are separated out into hoppers provided for this purpose by means of the defect selection unit. Document DE 10 2019 109 703 A1 shows and describes an arrangement for checking the quality of a battery cell whose transparent outer skin encloses an inner space. Inside the interior space, i.e. under the outer skin, an (additional) glass pin or a lithium metal wafer is arranged, which changes its optical appearance in the presence of a predetermined hydrogen fluoride concentration. Accordingly, this glass pin or lithium metal flake is analysed in a detailed manner by optoelectronic measurement to determine the hydrogen fluoride concentration and thus the quality of the battery cell. Finally, document EP 3 869 603 A1 describes a method for examining the quality of laminated electrode-separator composites and batteries with electrode-separator composites, which is suitable for large-scale production and ensures that the layers are securely and reliably connected to one another. The examination includes a detection of at least a proportion of the surface of the electrode separator composite by means of a detection device to generate a measurement result and the evaluation of the measurement result. The detection device is particularly suitable for determining the surface topography, surface temperature and/or surface colour. This may be done by means of an optical sensor, a photographic apparatus and/or a camera. In this case, the detection device may comprise at least one lighting device that can emit light onto the surface of the electrode-separator composite to be examined. The evaluation may comprise image processing and/or image analysis.

Further systems for inspecting objects are known from documents DE 10 202 205 760 A1, CN 111 965 185 A, DE 10 2020 109 945 A1 and DE 10 2011 113 670 A1.

The known methods mentioned above are either comparatively complex or only allow a very limited statement to be made about the quality of a three-dimensional object, in particular of a pouch cell. Therefore, the object of the present invention is to create a simple and cost-effective device for inspecting an object that allows a comprehensive assessment of the quality of that object. Similarly, the object of the invention is to provide a corresponding inspection method.

### SUMMARY

The above object is achieved by means of a device for inspecting three-dimensional objects, in particular battery cells in the form of pouch cells, wherein each object comprises a housing that is essentially cushion-shaped or cuboid-shaped and has a top side and a bottom side (the housing may include a first protruding connection tab (referred to in the following as tab) and at least a second protruding connection tab (referred to in the following as tab)), wherein the top side of the housing is composed of at least one (e.g. essentially horizontally arrangeable) upper surface section and a plurality of lateral surface sections which run obliquely, in parallel or perpendicularly to the at least one upper surface section or form corner sections,

wherein the bottom side of the housing is composed of at least one (e.g. essentially horizontally arrangeable) bottom surface section and a plurality of lateral surface sections that run obliquely, in parallel or perpendicularly to the at least one bottom surface section, or form corner sections, the device comprising
a motion detection unit that captures motion data with respect to each object to be inspected, with regard to relative motion to a line lighting unit (motion state) and with regard to an arrangement in a predetermined position and over a predetermined time period with respect to an area lighting unit (rest state),
the line lighting unit for illuminating a line-shaped area of the top side of the object to be inspected,
the area lighting unit for illuminating the top side of the housing of the object to be inspected from above in its rest state,
optionally, at least one first deflecting mirror arranged next to respectively one side of the housing in the rest state of the object and
a matrix camera arranged above the object to be inspected for capturing image data in a field of view, wherein the field of view is configured
   for line-by-line capturing of the line lighting unit's light reflected from the line-shaped area of the top side into the matrix camera in the motion state of the object to be inspected and
   for the matrix-wise capturing of the area lighting unit's light reflected upwards from the top side in the rest state of the object to be inspected, including optionally the light reflected from the lateral surface sections, if applicable via the at least one first deflection mirror, into the matrix camera, and
      wherein a data processing unit is provided, which is configured to receive and process the image data recorded by the matrix camera and the detected motion data, wherein the data processing unit assigns the image data captured line-by-line in the motion state and the image data captured matrix-wise in the rest state to the respective object to be inspected and determines from these image data the presence of a defect of at least one defect type and/or determines a quality score which allows an assessment of the quality of the object.

The device is used to inspect three-dimensional objects, for example flat objects in the form of a pouch or cuboid, in particular for battery cells, for example pouch cells. In one embodiment, the present invention may be used for a flat object, wherein a three-dimensional object is referred to as a flat object if it exhibits significantly less spatial expansion in one spatial direction (e.g. height) than in the other two spatial directions and therefore essentially has the shape of a flat cuboid or a pouch shape or a shape similar to these shapes. Alternatively, the dimension in one spatial direction may also be larger, so that the object is described as essentially cuboid. In this context, ‘essentially’ means that the shape of the object approximates that of a pouch or a cuboid. For example, the cuboid may have steeply sloping edges. In many cases, such an object also comprises a first connection tab (short: tab, e.g. the anode) and, if applicable, at least a second connection tab (short: tab, e.g. the cathode), each of which projects laterally. Each object comprises a housing having a top side and a bottom side opposite the top side, wherein any tabs that project belong to the housing. The device according to embodiments of the invention may be used both for inspecting three-dimensional objects comprising one or more such tabs and for inspecting three-dimensional objects without such tabs. In particular, the device is suitable for flat objects that comprise stepped or terraced sections, particularly on their edge, or the aforementioned connecting tabs. The object is therefore viewed in such a way that one of the two largest sides forms the top side and the opposite side, which is also large, forms the bottom side. When the top side is on top and the bottom side is on the bottom, the top side of the housing has at least one upper surface section that runs essentially horizontally and is the surface section of the top side with the largest dimension. Further horizontally running surface sections, which run parallel to the upper surface section of the top side, may be provided, for example a terrace surface section of the top side. The top side further comprises a plurality of lateral surface sections that run obliquely, in parallel or perpendicularly to the at least one upper surface section (e.g. edges or lateral surfaces) or form corner sections. The lateral surface sections also comprise the sections running parallel to the upper surface section or a surface of a protruding tab (tab surface). Accordingly, the bottom side of the housing comprises at least one substantially horizontally running bottom surface section, which is the surface section with the largest dimension. Further horizontally running surface sections, which run parallel to the “upper” surface section of the bottom side, may be provided, for example a terrace surface section of the bottom side. The bottom side further comprises a plurality of lateral surface sections that run obliquely, in parallel or perpendicularly to the at least one upper surface section (e.g. edges or lateral surfaces) or constitute corner sections. The first tab and the at least one second tab, if present, may, for example, project from a short side and/or a long side and each comprise an upper tab surface and a lower tab surface. For example, the first tab and the second tab project from a single short or long side. In this case, they are arranged adjacently. Alternatively, the first tab and the second tab may project from opposite short or long sides. The housing may have a substantially rectangular shape (without taking into account any tabs that may exist) when viewed from above on the top or bottom side of the housing. The short side is the short side of this rectangle and the long side represents the long side of this rectangle.

The movement of the three-dimensional objects to be inspected is carried out by means of a drive unit that causes the relative movement of the objects to be inspected to the line lighting unit at a predetermined speed (motion state), for example essentially parallel to the upper surface section, for example in the direction of the largest dimension of the upper surface section (length) or transversely thereto. The predetermined speed is, for example, at least 500 mm/s, e.g. at least 800 mm/s. Furthermore, the drive unit is configured to cause the object to be arranged at a predetermined position and for a predetermined time period in relation to an area lighting unit during the further movement of the respective object at rest (rest state). In this case, the predetermined time period for the arrangement of the object in the rest state may be before the motion state or after the motion state. The predetermined time period in the rest state may, for example, be at least 300 ms, e.g. at least 400 ms. In one embodiment, the drive unit is realised by a slide that can be moved in a predetermined manner on a linear unit. The slide comprises, for example, suction cups by means of which the housing of the object can be attached to the slide on its bottom side. The motion data for moving the three-dimensional object to be inspected (i.e. its arrangement in the motion state and in the rest state, the position of the object and/or its velocity etc.) is captured by a motion detection unit and transmitted to the data processing unit. There, the captured motion data is used together with the captured image data from the matrix camera to determine the presence of defects and/or the quality score.

The line lighting unit illuminates a line-shaped area on the top side of the pouch-like housing (optionally including the upper tab surface of the first tab and/or the second tab). For example, the line lighting unit is formed by a light with a plurality of LEDs arranged to illuminate a desired line-shaped area. In this case, one LED line or, for a wider line-shaped area, several LED lines lying adjacently (e.g. 2 to 10 LED lines) may be provided. In one embodiment, the line lighting unit may be switched in such a way that it illuminates each point of the line-shaped area with light of two different intensities (i.e. with high intensity A and with low intensity B). Accordingly, the line-by-line detection of the light reflected from the line-shaped area of the top side (optionally including the upper tab surface of the first tab and/or the second tab) is carried out with an adapted switching rhythm in the form ABABAB . . . (i.e. the two different intensities A, B are switched alternately). The line-by-line capture of the image data (capture frequency and time of capture) and the feed rate of the drive unit are synchronised for this purpose. This illumination is also referred to as High Dynamic Range (HDR) reflection bright field illumination.

The area lighting unit illuminates the top side of the housing (optionally including the upper tab surface of the first tab and/or the second tab) of the objects to be inspected from above. In one embodiment, the entire top side of the housing (optionally including the upper tab surface of the first tab and/or the second tab) or at least a greater section of the top side of the housing (optionally including the upper tab surface of the first tab and/or the second tab), for example at least 70%, e.g. at least 80%, of the entire top side of the housing is illuminated by the area lighting unit. For example, the light from the area lighting unit is incident on the top side of the housing (optionally including the upper tab surface of the first tab and/or the second tab) perpendicular or obliquely, e.g. at an angle of incidence in the range of 10° to 60° with respect to the horizontal direction. By means of the oblique illumination by the area lighting unit, defects such as indentations, protrusions, scratches, folding defects, edge cracks, defects at the sealing and similar topological defects may be easily detected. Defects in the form of absorbing defects (e.g. contamination, foreign bodies on the surface) may also be detected. The area lighting unit is realised by LED spots or other quasi-spotlights. In one embodiment, at least one second deflecting mirror is arranged above the position of the object to be inspected in the rest state, which extends perpendicular to the horizontal direction and deflects the light from the area lighting unit so that it falls obliquely from above onto the top side of the pouch-shaped housing (optionally with tabs). This may reduce the overall external dimensions of the inspection device.

The inspection device is characterised by the fact that, by means of a single matrix camera, the reflected light of the line-shaped illuminated area of the top side of the housing of the object to be inspected in the motion state is recorded line-by-line in the form of image data (image information, e.g. intensity and, in one embodiment, additionally a colour value) and the reflected light of the top side of the housing illuminated from above (including the upper tab surface, if applicable) is recorded matrix-wise in the form of image data of an object to be inspected arranged in the rest state in the form of image data (image information, e.g. intensity and, in one embodiment, additionally a colour value) and both captured image data is transmitted to the data processing unit. The matrix camera is, for example, arranged above the object when the object is in its rest state at the specified position, i.e., in this embodiment, the matrix camera is arranged above the rest state position of the object to be inspected. Line-by-line capture represents a subregion of the field of view of the matrix camera and results in one pixel line or several adjacently positioned pixel lines (e.g. pixel lines having 16 to 128 pixels) with image data, whereas matrix-by-matrix capture results in a pixel matrix with image data, wherein the pixel matrix also represents a subregion of the field of view. In one embodiment, the image data may be determined in a predetermined wavelength range. The field of view of the matrix camera is designed in such a way that matrix-wise image data and line-by-line image data are captured by a single fixed (i.e. during capture of image data immobile) matrix camera, which are subsequently assigned to the respective object by the data processing unit. In this context, the entire top side of the housing (optionally including the upper tab surfaces of the first tab and/or the second tab) or at least the section of the top side of the housing illuminated by the area lighting unit may be captured during matrix-wise capture, i.e. at least a greater section of the top side of the housing (optionally including the upper tab surface of the first tab and/or the second tab), for example at least 70%, e.g. at least 80%, of the entire top side of the housing of the object to be inspected.

The matrix camera may, for example, be designed as a CCD or CMOS camera. The matrix camera captures the light intensity of a large number of pixels in the field of view, which are arranged in rows and columns, i.e. in a matrix. For this purpose, the matrix camera comprises a light-sensitive element (e.g. a CCD or CMOS sensor) for each pixel. The size of the area captured by each light-sensitive element determines the resolution of the matrix camera. The matrix camera may, for example, comprise a field of view of 9344×7000 pixels or 8192×8192 pixels and thus captures image data with a size of 805×603 mm. The line-by-line capture may accordingly comprise an area of 16 to 128×1000 to 8192 pixels, for example. The matrix camera is also arranged in such a way that it looks vertically from above at the object to be inspected in the rest state, so that it sees this section of the field of view in focus. The matrix camera is focused in such a way that it comprises a sharpness that is as uniform as possible over the entire field of view. In particular, this is realised for a line of sight in which the image data from the object reaches the matrix camera via mirrors. This is achieved by a corresponding aperture setting, which realises the necessary depth of field.

In one embodiment, the matrix camera is configured to (e.g. is controlled by the data processing unit in such a way) that the line-by-line and the matrix-wise capture of the image data takes place in a recording sequence (temporal sequence of a sequence of recordings of the matrix camera over its entire field of view). This may be synchronised with a corresponding control of the lighting (i.e. the line lighting unit and/or the area lighting unit). In one embodiment, the image data to be captured line-by-line of a first object to be inspected (in motion state) may be captured at least partially simultaneously with the image data to be captured matrix-wise of a second object to be inspected that is different from the first object (in rest state). Such a design of the recording sequence may shorten the overall time required for the quality assessment of the object.

This means that the matrix camera is configured such that at least one of its captures (i.e. in the same capture) of a recording sequence contains
line-by-line the line lighting unit's light reflected from the line-shaped area of the top side in the motion state of a first object and
matrix-wise the area lighting unit's light reflected upwards from the top side (in one embodiment of the entire top side and/or optionally including the upper tab surface of the first tab and/or the second tab) in the rest state of a second object, optionally including the light reflected from the lateral surface sections of the second object, if applicable via the at least one first deflection mirror, into the matrix camera, wherein the second object is different from the first object.

Capture and illumination sequences may, for example, include a plurality of line-by-line captures (for example, between 50 and 120 line-by-line captures) of the light reflected from the line-shaped area of the top side (optionally including the upper tab surface of the first tab and/or the second tab) and, where partly in the same capture, one of some (between 5 and 20) matrix-by-matrix captures of the top side (optionally including the top tab surface of the first tab and/or the second tab). Alternatively, the image data to be captured line-by-line and the image data to be captured matrix-wise of two different objects may be recorded sequentially by the matrix camera in the capture sequence. In this case, in order to save time, only sections of the entire pixel matrix of the matrix camera may be read out, e.g. the corresponding section of the line-by-line capture and the corresponding section of the matrix-wise capture.

When capturing the image data, the matrix camera is at rest (i.e. it does not move, nor do parts of it move) and the dimensions of the field of view of the matrix camera are such that both the image data to be captured line-by-line and the image data to be captured matrix-wise are contained in the same field of view. The object to be inspected is in a motion state during line-by-line capture, i.e. the object to be inspected continues to move while the image data is being created. In contrast, the object to be inspected is at rest at a predetermined position and for a predetermined time period (i.e. at rest state) during matrix-wise capture, so that the image data captured matrix-wise can be determined accurately. Furthermore, at least two first deflection mirrors may be provided next to the object to be inspected, which may also be captured by the field of view of the matrix camera and which provide further image data of the lateral surface sections of the top side of the object to be inspected. In this embodiment, these are captured together (simultaneously, i.e. in the same recording) with the matrix-wise capture of the object to be inspected. The image data captured line-by-line and the image data captured matrix-wise, including the image data transmitted via the first deflection mirrors, if applicable, are assigned to the respective inspected object and included in the determination of the presence of a defect of at least one defect type and or a quality score. Due to its technical features described above, the inspection device enables the quality of various objects, in particular pouch cells, to be assessed quickly and with little expenditure. In particular, only a single matrix camera is sufficient for the quality assessment of the top side of the object.

From the image data transmitted by the matrix camera to the data processing unit, the presence of a defect of at least one defect type is determined by appropriate data processing and/or a quality score is determined, which allows an assessment of the quality of the object. Defect types include, for example, inclusions, craters (dents), protrusions (bumps), contamination (dust, electrolyte residues), pseudo-edges, orange peel, pores, cracks, grinding marks, specks, surface defects, blistering, scratches and wet prints. This is explained in more detail below.

In the above embodiment, the arrangement and inclination of the at least one first deflection mirror is such that the matrix camera receives the light reflected from the largest possible area of the respective lateral surface sections of the top side. In one embodiment of the device, at least two, in particular four, first deflection mirrors are provided, wherein in the rest state of the object each first deflection mirror is arranged next to a respective side of the housing. With four first deflection mirrors, the reflected light of the lateral surface sections of all sides of the housing may be captured. As an example, each first deflection mirror is designed in such a way that its length (largest dimension, dimension parallel to the respective side next to which the first deflection mirror is arranged) corresponds at least to the length of the respective side of the housing. Further, in one embodiment, each first deflecting mirror is arranged in a horizontal direction at a distance of at least 30 mm from the respective side of the housing. In a further embodiment, the width of each first deflecting mirror (dimension perpendicular to the respective side next to which the respective first deflecting mirror is arranged) is at least 20 mm. The tilt angle of the first deflecting mirror is, for example, at least 300 to the horizontal direction. In addition, it is advantageous for the accuracy of the inspection if the deflecting mirrors realise a very good optical imaging quality in order to avoid distortions in the image of the matrix camera.

In one embodiment of the device, the illuminated line-shaped area extends over the entire length of the top side (optionally including the protruding first and second tabs). Here, the length of the top side is the dimension of the housing in the direction of its largest dimension. In this embodiment, the illuminated line-shaped area may be used to obtain image data with respect to the entire top side (and optionally both tabs) when the entire object is moved past the line lighting unit.

In one embodiment of the device, the area lighting unit is configured to illuminate the top side, e.g. the entire top side, of the object's housing (optionally including the upper tab surface of the first tab and/or the second tab) in the rest state of the object to be inspected temporally in succession from at least two different directions obliquely from above, and the matrix camera is correspondingly configured to temporally successive matrix-wise capture of the image data of the light reflected from the top side of the housing which is produced by the illumination from the at least two directions of the area lighting unit, and the data processing unit is correspondingly configured to receive and process the at least two image data captured matrix-wise during illumination from at least two directions of the area lighting unit, associates these image data with the respective object and uses these image data to determine the presence of a defect of at least one defect type and/or the quality score, which allows the quality of the object to be assessed.

In one embodiment of the device, the data processing unit uses a maximum image, a topology image and/or an absorption image of the image data determined from at least two image data captured matrix-wise during illumination from the at least two directions of the area lighting unit to determine the presence of a defect of at least one defect type and/or the characteristic score. The matrix image, the topology image and/or the absorption image are each generated from the n matrix-wise captures of image data of a predetermined image data portion captured temporally successively. The maximum image represents the image data of the areas that are best accessible in relation to the respective lighting situation and are therefore recognised as the brightest. The topology image has the advantage that it emphasises topology changes in the image, while the absorption image accentuates defects caused by the absorption of light (e.g. contamination on the surface). For example, the image data is generated pixel-identically, i.e. the image data of the at least two matrix-wise captures of the entire top side (optionally including the upper tab surface of the first tab and/or the second tab) are each generated from the same points on the surfaces. Each of these matrix-wise captures is referred to as an image data matrix M, wherein at least two image data matrices Mk (k≥2, k=2 . . . n) are captured for each object. A pixel Pi of the captured first image data matrix M1 thus corresponds to the same location on the surface of the top side (optionally including the upper tab surface) as the same pixel Pi of the captured second (third, fourth, etc.) image data matrix Mk (M2, M3, M4, . . . Mn). The captured light intensity in the pixel Pi is denoted as i(Pi). The captured light intensity of the first image data matrix M1 at pixel Pi is referred to as i₁(Pi).

The maximum image may be determined by forming the maximum of the light intensities of all image data matrices Mk in the respective pixel Pi, i.e. Max(iᵢ(Pi), i₂(Pi)) for two determined image data matrices M1, M2 for two illuminations from two different directions or Max(i₁(Pi), i₂(Pi), . . . in(Pi)) if n illuminations from n different directions are used. In one embodiment, n=4. The maximum is calculated for each pixel Pi and—represented in the entire matrix (maximum matrix)—results in the maximum image.

The topology image and the absorption image may be determined by first separately applying two differently parameterised low-pass filters (e.g. box filters) to each image data matrix Mk of each lighting situation independently of each other and subtracting them from each other:

$$Fk = low - pass 1 ( Mk ) - low - pass 2 ( Mk )$$

Herein, the parameters of the two low-pass filters low-pass1 and low-pass2 differ, for example, in such a way that the first parameter of the first low-pass filter low-pass1 is smaller than the second parameter of the second low-pass filter low-pass2. The light intensity assigned to each pixel Pi of the matrix Fk by this operation is referred to as fk(Pi) (k=2 . . . n). Subsequently, from the resulting matrices Fk analogously to the maximum image above the minimum or maximum pixel by pixel over all matrices a minimum matrix MinM and a maximum matrix MaxM is determined, wherein each point Pi of the minimum matrix MinM is calculated as Min(f1(Pi), f2(Pi), . . . fn(Pi)) and each point Pi of the maximum matrix MaxM is calculated as Max(f1(Pi), f2(Pi), . . . fn(Pi)). Subsequently, a matrix H is determined with the values h(Pi), which is determined from the product—again determined pixel by pixel—of the minimum value and maximum value calculated at the respective point Pi with a scaling factor a (for example a=64). This means that for each point Pi, the value is

$$h ( Pi ) = Min ( f 1 ( Pi ) , f 2 ( Pi ) , … fn ( Pi ) ) * Max ( f 1 ( Pi ) , f 2 ( Pi ) , … fn ( Pi ) ) * a$$

Finally, a matrix Q with the values q(Pi) is determined from this, wherein

$$q ( Pi ) = sqrt ( abs ( h ( Pi ) ) ) ,$$

wherein abs(q(Pi)) is the absolute value of the value q(Pi) and sqrt( ) is the root function. This results in the values of the topology matrix T with the values t(Pi) as follows:

$$t ( Pi ) = q ( Pi ) if h ( Pi ) \leq 0 or t ( Pi ) = 0 if h ( Pi ) > 0.$$

Accordingly, the values of the absorption matrix A with the values a(Pi) are obtained as follows

$$a ( Pi ) = q ( Pi ) if h ( Pi ) > 0 or a ( Pi ) = 0 if h ( Pi ) \leq 0.$$

The topology matrix T calculated in this way with the values t(Pi) is also referred to as the topology image and the absorption matrix A with the values a(Pi) is also referred to as the absorption image.

If the matrix-wise capture of the light reflected upwards from the top side (optionally from the entire top side and/or optionally including the upper tab surface) of the area lighting unit is carried out four times with illumination obliquely from above from four different directions, the directions are selected, for example, so that the illumination is carried out from both opposite long sides and from both opposite short sides of the housing. Alternatively, the lighting may illuminate the top side from the direction of each of the four corners of the housing. In one embodiment, it is advantageous if the captures are produced with illuminations, wherein all illumination directions optionally cover an angle of 360° in total with regard to their components running in the plane of the upper surface section (i.e. when illuminating from four different directions, the illumination is provided from directions offset by 90° in each case, or when illuminating from six different directions, the illumination is provided from directions offset by 60° in each case, etc.).

In one embodiment of the device, the matrix camera is calibrated in such a way that perspective and optical distortion from the image data captured matrix-wise can be taken into account by the data processing unit. For such a calibration, the method described in the article ‘Digital camera self-calibration’, C. S. Fraser, ISPRS Journal of Photogrammetry & Remote Sensing 52 (1997), pages 149-159 is used, for example. In one embodiment of the device, the data processing unit is configured to determine at least one dimension of the object and/or at least one size of a detected defect after taking into account the perspective and the optical distortion. For this purpose, for example, a look-up table is determined in advance on the basis of the calibration, by means of which a conversion of a pixel number into a unit of length or area is provided. The look-up table is stored, for example, in a memory unit of the data processing unit.

In one embodiment, a position correction may additionally be carried out using the calibration and by using fixed points (e.g. the corner points of the housing) by means of the data processing unit. Here, the coordinates of the four corner points of the housing, for example, are determined by software-based ‘probing’ of the housing in a horizontal and vertical direction. Probing involves examining the respective rows and columns of the image data matrix for a change in intensity (large increase or decrease in intensity from one pixel to the next pixel). Position correction is advantageous for comparing the captured image data of the matrix with corresponding target values to determine defects or to determine a quality score, as the object may not always be in exactly the same position in the rest state. In one embodiment, the position correction may also be used to determine the location (position) of each detected defect on the top side (optionally including the upper tab surface). Based on this location information, a marking device downstream of the inspection device may, for example, mark the defect by applying (e.g. spraying on) a water-soluble colour by encircling it on the surface of the object. Alternatively or additionally, knowing the location of the defect may make it easier to control a device for removing the defect.

The above object is also solved by a system having a first device for inspecting three-dimensional objects with the features described above and a second device for inspecting three-dimensional objects with the features described above, wherein the second device for inspecting is arranged downstream of the first device for inspecting in the transport direction, wherein the bottom side of the object, which is located on top after the object has been turned over after the first device for inspecting three-dimensional objects, is inspected by means of the second device for inspecting three-dimensional objects. The bottom side of the object is, for example, inspected in the same way as the top side of the object. For example, a turning device may be arranged in the transport direction between the first device for inspecting and the second device for inspecting, which turns the object over in such a way that the bottom side is on top for inspection in the second. The system enables defects to be detected and/or a quality score to be determined both on the top side and, after passing the turning device, on the bottom side of the object (optionally including the bottom tab surface). For example, the turning device is realised by means of grippers and/or suction cups.

The above object is further solved by a method for inspecting 3-dimensional objects, in particular pouch cells, wherein each object comprises a housing that is essentially pouch-shaped or cuboid-shaped and has a top side and a bottom side that is opposite the top side, wherein the top side of the housing is composed of at least one upper surface section and a plurality of lateral surface sections, which run obliquely, in parallel or perpendicularly to the at least one upper surface section or form corner sections, wherein the bottom side of the housing is composed of at least one lower surface section on the bottom side as well as a plurality of lateral surface sections which run obliquely, in parallel or perpendicularly to the at least one lower surface section or form corner sections, wherein the method comprises the following steps:
detecting motion data with regard to a relative movement of each object to be inspected to a line lighting unit (motion state) and with regard to an arrangement of the respective object in a predetermined position and over a predetermined time period in relation to an area lighting unit (rest state) by means of a motion detection unit,
illuminating a line-shaped area of the top side of the object to be inspected by means of the line lighting unit, which, for example, emits line-shaped HDR reflection bright field illumination,
illuminating the top side of the housing of the object to be inspected from above in its rest state by means of the area lighting unit,
capturing image data in a field of view by means of a matrix camera arranged above the rest state position of the object to be inspected, wherein the field of view is configured
   for line-by-line capturing of the line lighting unit's light reflected into the matrix camera by the line-shaped area of the top side in the motion state of the object to be inspected and
   for matrix-wise capturing of the area lighting unit's light reflected upwards from the top side in the rest state of the object to be inspected, optionally including the light reflected from the lateral surface sections of the object to be inspected, if applicable via at least one first deflecting mirror into the matrix camera (wherein the at least one first deflecting mirror is arranged next to one respective side of the housing in the rest state of the object),
receiving and processing the image data captured by the matrix camera and the detected motion data by means of a data processing unit, wherein the data processing unit assigns the image data captured line-by-line in the motion state and the image data captured matrix-wise in the rest state to the respective object to be inspected and determines from these image data the presence of a defect of at least one defect type and/or determines a quality score, which allows an assessment of the quality of the object.

In one embodiment of the method, the illuminated line-shaped area extends over the entire length of the top side and/or in that at least four first deflecting mirrors are provided, wherein each deflecting mirror is arranged in the rest state of the object next to a respective side of the housing.

In one embodiment of the method, by means of the matrix camera, in at least in one of its captures/recordings of a detection sequence, it is captured (i.e. in the same recording/capturing step)
line-by-line, the line lighting unit's light reflected from the line-shaped area of the top side in the motion state of a first object and
matrix-wise the area lighting unit's light reflected upwards from the top side in the rest state of a second object, optionally including the light reflected from the lateral surface sections of the second object, if applicable via the at least one first deflection mirror into the matrix camera, wherein the second object is different from the first object.

In one embodiment of the method, by means of the area lighting unit, the top side of the housing (the entire top side or a greater part of the top side (see above)) of the object in the rest state of the object to be inspected is illuminated temporally in succession from at least two different directions obliquely from above and

by means of the matrix camera correspondingly temporally successive matrix-wise these at least two image data caused by the illuminations of the at least two directions of the area lighting unit are captured, wherein the image date is produced by reflected light of the area lighting unit, and
by means of the data processing unit the at least two image data captured matrix-wise are received and processed accordingly, these image data are assigned to the respective object and used to determine the presence of a defect of at least one defect type and/or the quality score, wherein the data processing unit uses, e.g., a maximum image of the image data, which was determined from the at least two image data captured matrix-wise when illuminated from the at least two directions of the area lighting unit, to determine the presence of a defect of at least one defect type and/or the quality score.

In one embodiment of the method, the matrix camera is calibrated in such a way that the image data processing of the data processing unit takes into account perspective and optical distortion contained the image data captured matrix-wise, wherein, for example, by means of the data processing unit, at least one dimension of the object and/or at least one size of a detected defect is determined after taking into account the perspective and the optical distortion.

The device for inspecting may comprise further lighting devices and/or cameras that illuminate predetermined particular sections of the surface of the housing or generate image data from these sections, which is used to carry out the inspection of the objects.

The method for inspecting the object may be realised on the basis of the captured image data as a computer-implemented method, i.e. as a method carried out with the data processing unit (computer). The method may also include controlling the line illumination unit and/or the area illumination unit and/or the matrix camera such that a predetermined recording and/or illumination sequence is realised. For this purpose, the data processing unit and the line lighting unit and/or the area lighting unit are connected to each other by wire or wirelessly. The matrix camera is also connected to the data processing unit by a wired or wireless connection, also for transmitting the image data captured by the matrix camera to the data processing unit.

The data processing unit for processing the image data and determining whether a defect of at least one defect type exists and/or determining which quality score can be assigned to the object comprises a processor, which is a functional module that interprets and executes instructions/commands of algorithms and comprises a command control unit as well as an arithmetic unit and a logic unit. The processor may comprise at least a microprocessor, a digital signal processor (DSP), an application specific integrated circuit (ASIC), a field programmable gate array (FPGA—digital integrated circuit into which a logic circuit can be programmed), a discrete logic circuit or any combination of these components. The data processing unit may also comprise a memory unit, an input module (e.g. keyboard or touchpad), a power supply module (e.g. battery) and a display module (e.g. display). The data processing unit may be configured as a real hardware resource, for example a smartphone, desktop computer, server, notebook, cluster/warehouse scale computer, embedded system or the like, or as a virtualised computer resource. Furthermore, the data processing unit may comprise a transmitter/receiver (transceiver) for the exchange of data/image data with a display device (display). The data processing unit also comprises an interface for exchanging data with the line lighting unit and/or the area lighting unit and/or the matrix camera and/or a control device for the drive unit.

As has already been indicated above, the method explained above may, for example be realised as a computer program or computer-implemented method comprising instructions which, when executed, cause a processor of the data processing unit to perform the steps of the above method, wherein the computer program comprises a combination of the steps and data definitions described above which enable the computer hardware to perform computing or control functions, and/or is a syntactic unit which conforms to the rules of a particular programming language and which consists of declarations and statements or instructions required for the functions, tasks or problem solutions explained above.

Further disclosed is a computer program product comprising instructions which, when executed by the processor of the data processing unit, cause the device to perform the steps of any or all of the methods defined above. Accordingly, a computer readable medium storing such a computer program product is disclosed. The computer program product may be a software routine.

Further advantages, features and possible applications of the invention are described below with reference to embodiments and the figures. All features described and/or illustrated form the subject matter of the present invention, even independently of their summary in the claims and their references.

### BRIEF DESCRIPTION OF THE FIGURES

Schematically shows:

FIG. 1 is a first perspective view from the side of an embodiment of a device according to the invention,

FIG. 2 is a second perspective view from another side of the embodiment according to FIG. 1,

FIG. 3 is a side view of the embodiment according to FIG. 1 with the peripheral rays of lighting devices and of the field of view of the matrix camera,

FIG. 4 is a front view of the embodiment according to FIG. 1 with the peripheral rays of a lighting device and a centre ray of the field of view of the matrix camera,

FIG. 5 is a front view of the embodiment according to FIG. 1 with the peripheral rays of lighting devices and the peripheral rays of the field of view of the matrix camera,

FIG. 6 is a lower section of the embodiment according to FIG. 1 with the field of view of the matrix camera in a view from above,

FIG. 7 is a perspective view of an embodiment of a system according to the invention,

FIG. 8 is a perspective view of a first example of the design of an object (pouch cell),

FIG. 9 is a perspective view of a second example of the design of an object (pouch cell) and

FIG. 10 a flow chart for an embodiment of a method for inspecting.

### DETAILED DESCRIPTION OF PARTICULAR EMBODIMENTS

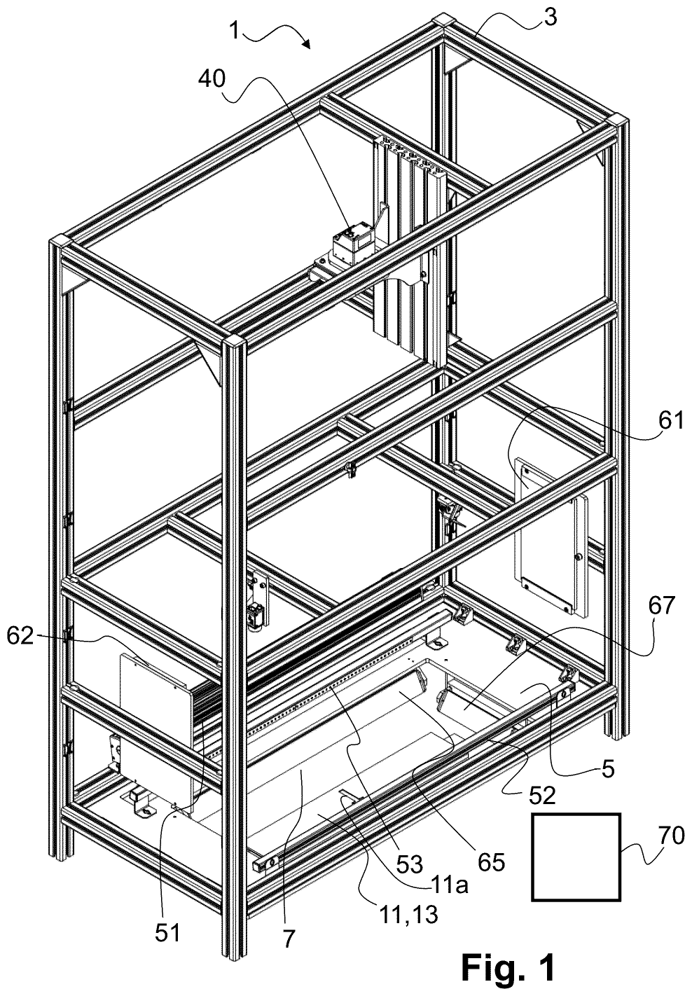

The embodiment of a device for inspecting shown in FIGS. 1 to 6 is used to inspect objects, e.g. in the form of pouch cells.

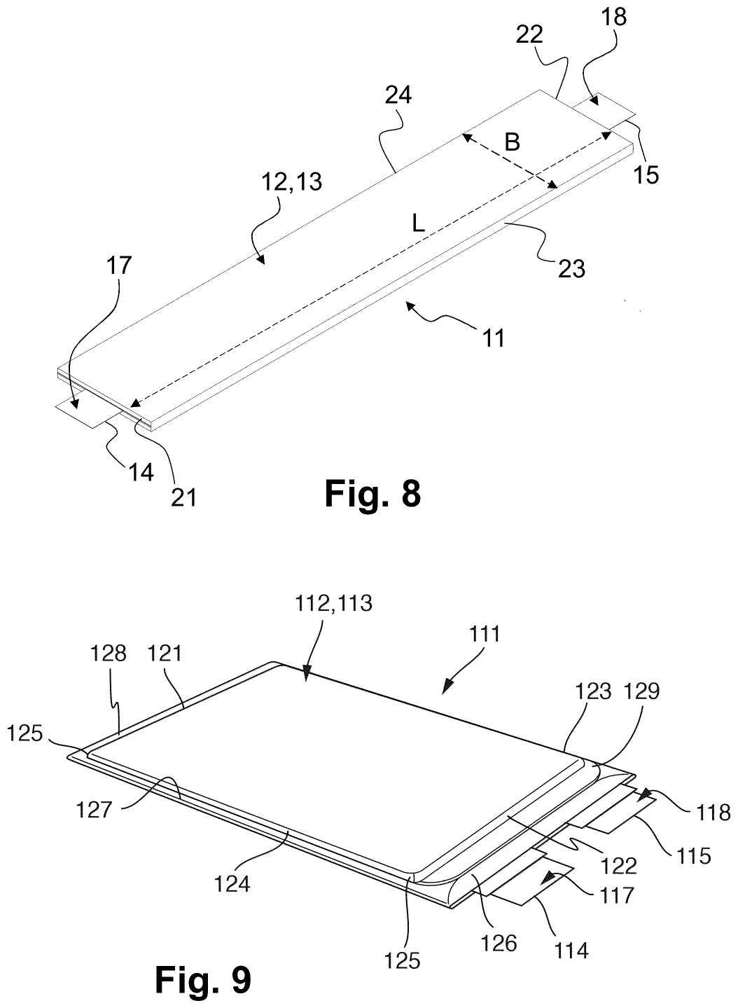

Two examples of pouch cells 11, 111 are shown in FIGS. 8 and 9.

The pouch cell 11 (see FIG. 8) comprises an essentially pouch-shaped housing 12. The housing 12 includes a first connecting tab (short: tab) 14 projecting from one short side and a second connecting tab (short: tab) 15 projecting from the opposite second short side. The housing 12 comprises a top side with a substantially horizontally extending upper surface section 13. The first tab 14 has an upper tab surface 17 and the second tab 15 has a corresponding upper tab surface 18. Corresponding lower tab surfaces of the tabs 14, 15 are not visible in FIG. 8. The housing 12 is essentially cuboid in shape. The housing 12 comprises lateral surfaces 21, 22 on the short sides and lateral surfaces 23, 24 on the long sides. The lateral surfaces 21, 22, 23, 24 run approximately perpendicular to the horizontal upper surface section 13. The horizontal upper surface section 13, the upper tab surfaces 17, 18 of the tabs 14, 15 and the lateral surfaces 21, 22, 23, 24 together form the top side of the housing 12. The bottom side is correspondingly shaped and comprises a horizontal lower surface section, lower tab surfaces of the tabs 14, 15 and the lateral surfaces 21, 22, 23, 24. In this embodiment, the lateral surfaces 21, 22, 23, 24 belong to both the top side and the bottom side, as these can also be detected when inspecting the top side and the bottom side respectively. In FIG. 8, the length of the housing 12 is labelled L and the width is labelled B (see dashed double arrow lines). Due to the simple design of the pouch cell 11, it is used to explain the mode of operation of the inspection device 1 (see FIGS. 1 to 6). Accordingly, however, the inspection device 1 may also be used for other types of objects, in particular in the form of pouch cells.

FIG. 9 shows a second embodiment of a pouch cell 111, which comprises a pouch-shaped housing 112 with a horizontal upper surface section 113. The housing also includes a first connecting tab 114 and a second connecting tab 115, which are adjacently arranged and project from a single short side 112. The first tab 114 has an upper tab surface 117 and the second tab 115 has an upper tab surface 118.

The pouch cell 111 further comprises side edges 121, 122, 123, 124 on the housing 112 around the horizontal upper surface section 113, which run at an angle to the horizontal upper surface section 113 and merge into it with a curve. Corners 125 are formed in the transition from one side edge to the neighbouring side edge 121, 122, 123, 124. Furthermore, the housing 112 comprises terrace sections 126, 127, 128, 129, each of which subsequently adjoin the side edges 121, 122, 123, 124 and run essentially parallel to the horizontal upper surface section 113. The top side of the housing 112 is formed by the horizontal upper surface section 113, the side edges 121, 122, 123, 124, the corners 125 and the terrace sections 126, 127, 128, 129.

The device 1 shown in FIGS. 1 to 6 for inspecting the pouch cell 11 has a support frame 3 on which a base plate 5 is arranged, which has a first through-going opening 7 and a second through-going opening 8 (see FIGS. 1, 2 and 6). Out of a plurality of pouch cells to be inspected, FIGS. 1 to 6 show two pouch cells 11, 31 to be inspected, which are guided past the inspection device 1 underneath the base plate 5, as illustrated by arrows 11a and 31a. The pouch cell 31 is another pouch cell with a structure as shown in FIG. 8.

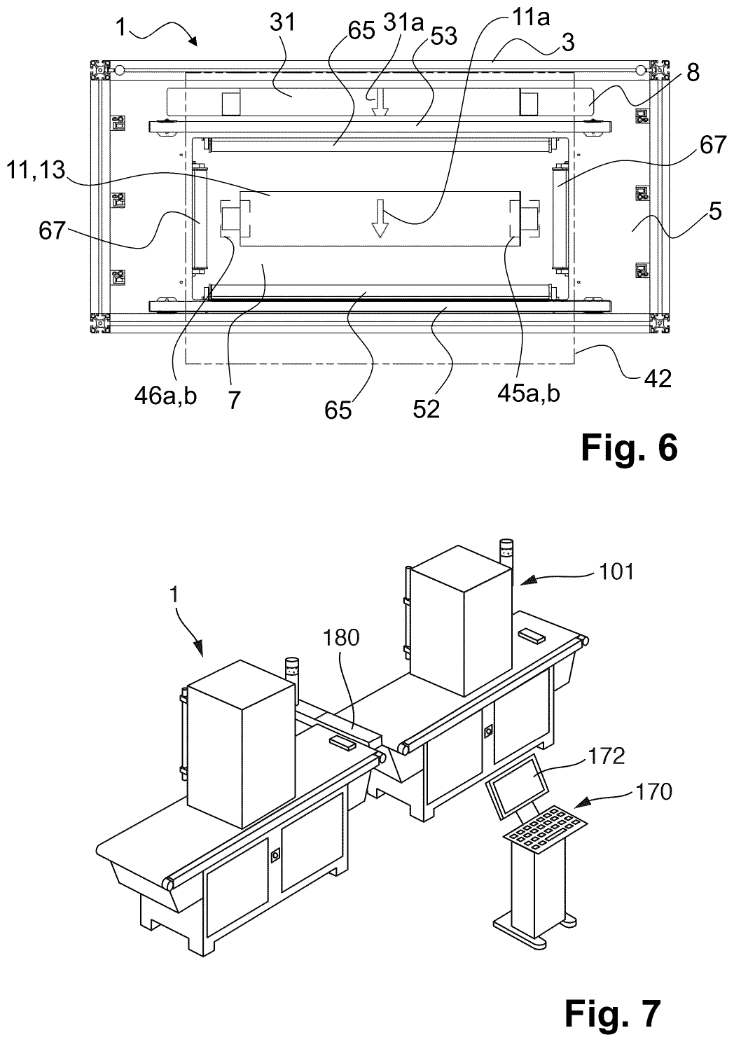

Above the base plate 5, a matrix camera 40 is arranged on the frame 3 viewing into the direction of the pouch cells 11, 31 from above through the openings 7, 8. Here, the pouch cells 11, 31 are arranged in such a way that the top side of the housing 12 is at the top in each case and the horizontal upper surface section 13 may be viewed from above with the matrix camera 40. The upper tab surface 17 of the first tab 14 and the upper tab surface 18 of the second tab 15 are also captured by the matrix camera 40. Here, the field of view 42 of the matrix camera 40 is so large (see in particular FIG. 6) that it extends over both openings 7, 8 in such a way that not only the pouch cells 11, 31 arranged under the respective opening 7, 8 are covered by the field of view 42 of the matrix camera over their entire length and width (viewed from above), but also the deflecting mirrors 65, 67 arranged next to the pouch cell 11.

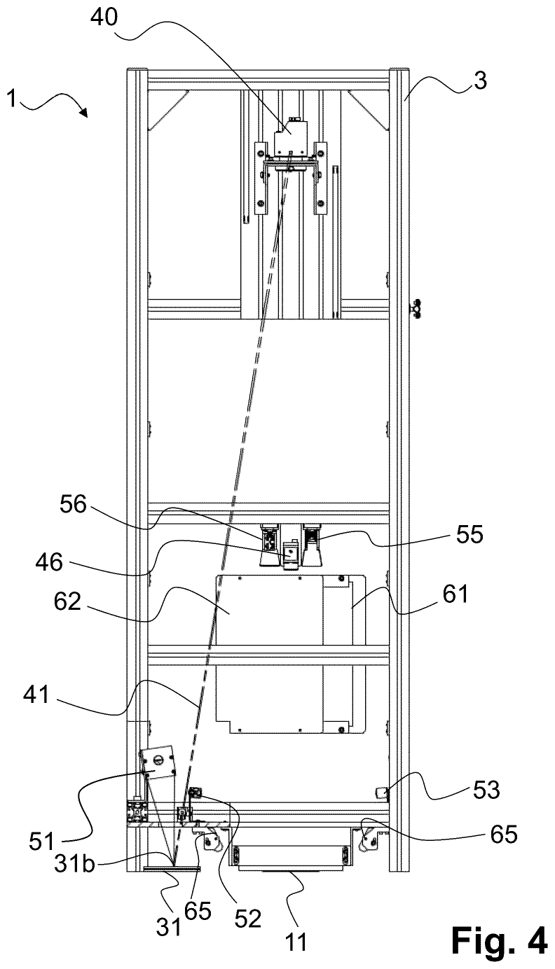

Furthermore, a line lighting unit 51 is provided on the frame 3, which illuminates a line-shaped area 31b of the top side of the housing and of the upper tab surfaces of the tabs. As can be seen from FIG. 4, the light reflected from the top side of the housing (including the upper tab surface) reaches the matrix camera 40 via the viewing ray 41 and is captured there. The matrix camera 40 thus captures the respective illuminated line-shaped area 31b of the pouch cell 31 line-by-line, wherein the pouch cell 31 moves transversely to the length of the opening 8 (see arrow 31 A in FIG. 6) during the capture, i.e. is in the motion state. A plurality of recordings is thus generated by means of the matrix camera 40. Each recording includes a respective capture of the respective illuminated line-shaped area of the top side of the housing (including the upper tab surfaces) of the pouch cell 31 moving past. The pouch cell is moved in the motion state by means of a drive unit described in more detail below and is caused to enter a rest state for a predetermined time period and is moved out of the inspection device from the rest state.

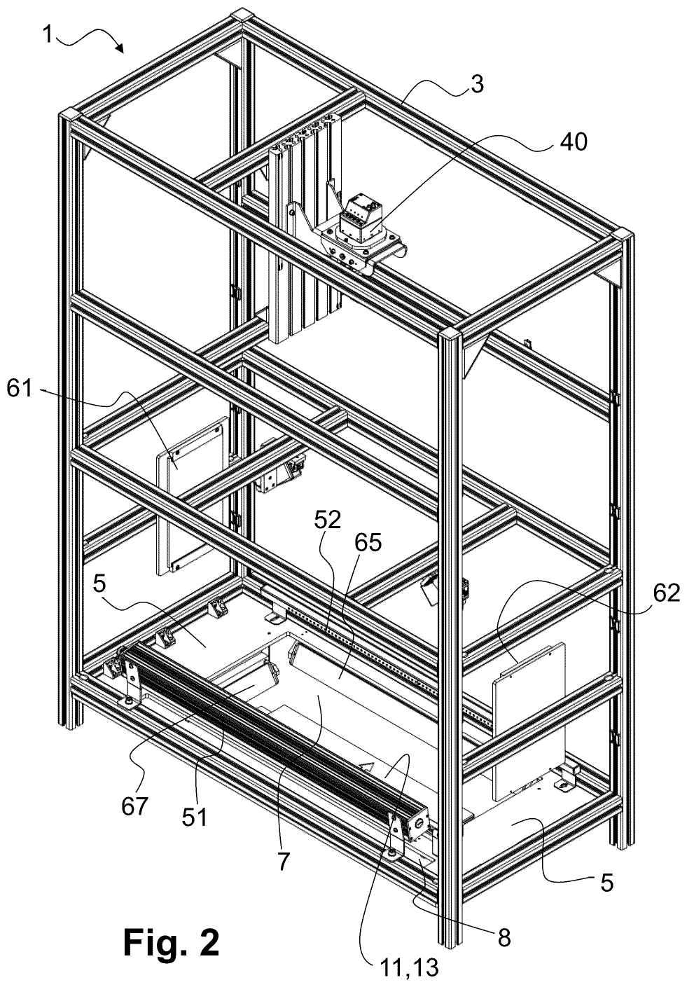

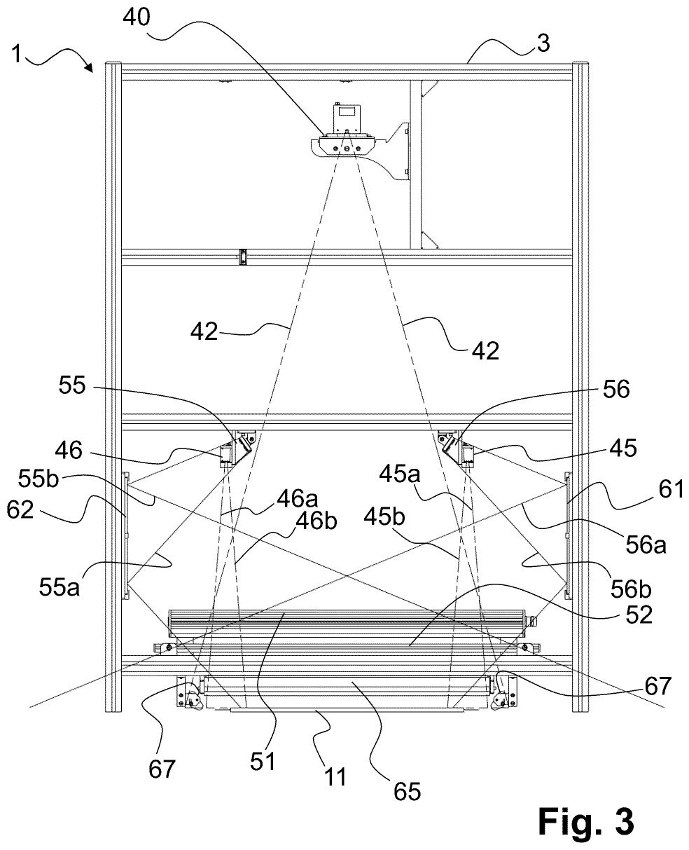

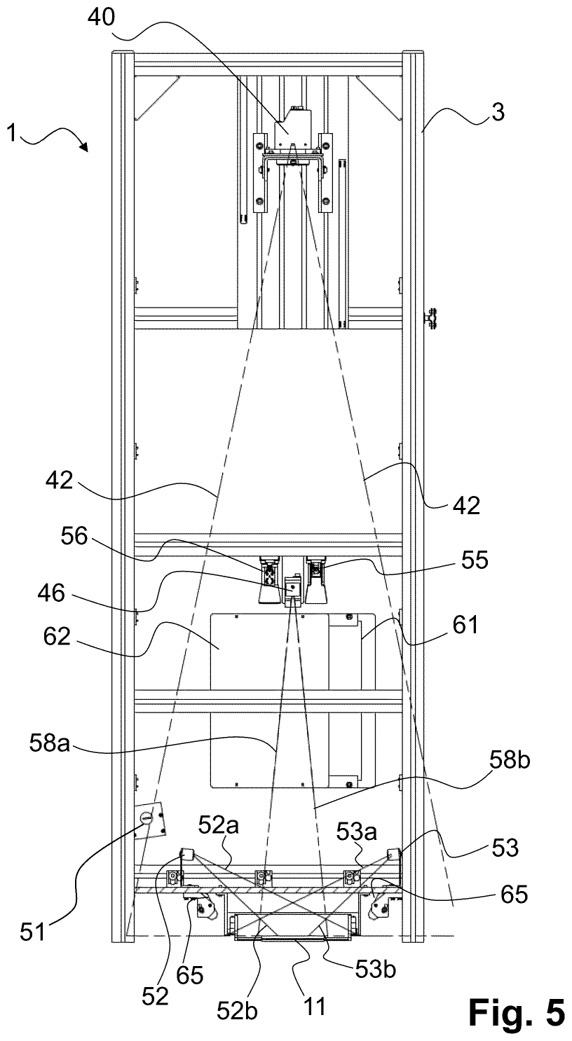

In addition, four area lighting units 52, 53, 55, 56 are provided on the frame. As can be seen from FIGS. 2, 3, 5 and 6 and the peripheral rays 52a and 52b or 53a, 53b of the area lighting units 52, 53 show, the area lighting units 52, 53 illuminate the top side of the housing 12 (including the upper tab surface 17, 18 of the tabs 14, 15) of the pouch cell 11 over the entire length L obliquely from above, so that in particular the side opposite the respective area lighting unit 52, 53 is captured in relation to the width of the pouch cell 11 (compare in particular FIG. 5), which is arranged below the opening 7 in the base plate 5. As can be seen from FIG. 3, the area lighting units 55, 56 illuminate the top side of the housing 12 (including the upper tab surface 17, 18 of the tabs 14, 15) via the mirrors 61, 62. Here, the light emitted by the area lighting unit 55 via the mirror 62 essentially illuminates the opposite first end of the pouch cell 11 and the light emitted by the area lighting unit 56 via the mirror 61 essentially illuminates the second end of the pouch cell 11 opposite the first end of the pouch cell (in the longitudinal direction). This can be understood by following the peripheral rays 55a, 55b, 56a and 56b. The area lighting units 52, 53, 55, 56 also partially illuminate the lateral surfaces 21, 22, 23, 24, so that reflections from these lateral surfaces and from the horizontally extending upper surface section 13 of the housing 12 are captured by the matrix camera 40. The light reflected from the lateral surfaces 21, 22, 23, 24 by the area lighting units 52, 53, 55, 56 is captured in particular via the deflecting mirrors 65, 67, which are provided next to the pouch cell 11 arranged below the opening 7 in such a way that the lateral surfaces 23, 24 on the long sides of the housing 12 of the pouch cell 11 are viewed by means of the deflecting mirrors 65, while the deflecting mirrors 67 serve to capture the lateral surfaces 21, 22 on the short sides of the housing 12 of the pouch cell 11.

The illumination by means of the area lighting units 52, 53, 55, 56 now takes place in such a way that these are each switched on one after the other so that the pouch cell 11 is illuminated obliquely from above, while the other three area lighting units are each switched off. For example, the illumination is first provided by the area lighting unit 52, then by the area lighting unit 55, then by the area lighting unit 53 and finally by the area lighting unit 56. The matrix camera 40 captures the reflected light in each of the four lighting states, wherein the pouch cell 11 is in the rest state in all four lighting states, i.e. in the same, predetermined position below the opening 7 in the base plate 5. Accordingly, four recordings of the entire top side of the housing 12 (including the upper tab surface 17, 18) are generated by means of the matrix camera 40, which capture these areas four times in a matrix, namely one time each when the area lighting unit 52, area lighting unit 55, area lighting unit 53 and area lighting unit 56 are switched on, wherein the pouch cell 11 is in the same position in each case.

In the four matrix-wise captures of the entire top side of the housing 12 (including the upper tab surface 17, 18), the lateral surfaces 21, 22, 23, 24 are also captured via the deflecting mirrors 65, 67, because the light reflected from these lateral surfaces 21, 22, 23, 24 reaches the matrix camera 40 via the deflecting mirrors 65, 67, because the field of view 42 of the matrix camera 40 includes these areas, as shown in FIG. 6.

The plurality of line-by-line captures and matrix-by-matrix captures of the pouch cells 11, 31 by the matrix camera 40 are transmitted to the data processing unit (computer) 70 (see FIG. 1) after they have been captured. The data processing unit 70 receives the image data from the line-by-line and matrix-by-matrix captures of the respective pouch cell 11, 31.

In this connection, the motion state and the rest state of the pouch cells 11, 31 are captured by means of a motion detection unit of the inspection device. For example, by monitoring the movement of a predetermined marking on the pouch cell 11, 31, for example a barcode, or corresponding signals from the drive unit, motion data is generated, which in particular contains information on the respective motion state in which the respective pouch cell 11, 31 is located. For example, the motion unit may transmit information to the motion detection unit that a pouch cell is ready for inspection (start signal). From this point in time, the motion detection unit may continuously capture the motion data of the motion unit and thus of the respective pouch cell (e.g. the speed of movement of the motion unit). Alternatively or additionally, the motion detection unit receives a signal when the line-by-line capture of the respective pouch cell is complete. Subsequently, a signal is generated by the motion unit or by means of a marking of the pouch cell and transmitted to the motion detection unit when the respective pouch cell is at the predetermined position of the rest state and remains there stationary. Once the matrix-wise capture of the respective pouch cell has been completed, the motion detection unit then generates another signal indicating that the respective pouch cell may be transported out of the inspection device. These signals also represent important motion data that is required for processing the image data.

This image data and the motion data are further processed and analysed by means of the data processing unit 70 and, as will be shown in more detail below, the object is assessed with regard to the presence of a defect of at least one defect type and/or a quality score is determined, which allows an assessment of the quality of the pouch cell 11, 31. In this context, the image data determined at different points in time from the line-by-line capture and the matrix-by-matrix capture are assigned to the respective pouch cell 11, 31 or to the motion state and to the rest state. This may, for example, be done using the motion data transmitted by the motion detection unit for the motion state and rest state of the respective pouch cell 11, 31. In this process, the image data of the recordings generated is corrected with regard to the image crop, the mirror distortion, the line-by-line capture (so-called line scan correction) and with regard to the position associated with the respective motion state or rest state.

The image data of the line-by-line capture of the respective pouch cell 11, 31 may be used, for example, to search for defects using bright field illumination (reflection bright field (RBF) illumination) or to determine a quality score, which relates in particular to an evaluation of the tab surfaces and a possible contamination by electrolytes.

For example, as explained in more detail below, a quality statement (quality score) is generated by the data processing unit 70 from the number, defect type and size/dimension of detected defects.

Further cameras 45, 46 are also arranged on the frame 3, which are attached to the frame 3 underneath the matrix camera. They observe the top side of the pouch cell 11 from above (see peripheral rays 45a, 45b, 46a, 46b) in such a way that they observe a top tab surface 17 of the first tab 14 and a top tab surface 18 of the second tab 15, as well as an adjacent portion of the upper surface section of the top side 13. The further cameras 45, 46 generate images with a higher resolution in the indicated portions of the pouch cell 11. The image data obtained from the corresponding fields of view are transmitted to the data processing unit 70 and further information with regard to the presence of smaller defects is generated therefrom.

FIG. 7 shows a system according to the invention for inspecting a pouch cell. The top side of the pouch cell (e.g. pouch cell 11) is first inspected by the inspection device 1. Subsequently, the pouch cell (e.g. pouch cell 11) reaches the turning unit 180 with a turning device and grippers with suction cups, which turns the pouch cell (e.g. pouch cell 11) so that the bottom side is now on top. Subsequently, the pouch cell (e.g. pouch cell 11), namely its bottom side (which is up there), is inspected by means of an inspection device 101, which is identical in construction to the inspection device 1. The processing of the image data obtained by means of the inspection devices 1, 101 with regard to the pouch cell (e.g. pouch cell 11) and the determination generated from this image data as to whether a defect/several defects of at least one defect type are present and/or determination of a quality score which allows an assessment of the quality of the object is carried out by means of the data processing unit 170, which is connected to a display 172 for displaying the results of the inspection. The pouch cell (e.g. pouch cell 11) is transported from the first inspection device 1 to the turning device 180 and to the second inspection device 101 by means of a drive unit comprising, for example, slides which are displaceable on a linear unit. The respective pouch cell is attached to a slide by means of suction cups. After completion of the capture of the image data by the matrix camera 40 and optionally by the further cameras 45, 46, in particular after completion of the matrix-wise capture of the respective pouch cell, a corresponding signal is generated by the inspection device, which is transmitted to the control of the drive unit. The drive unit is then controlled in such a way that it moves the respective pouch cell out of the respective inspection device 1, 101 and, if necessary, moves it to the turning device 180 in order to be subsequently turned and then transported to the second inspection device 101.

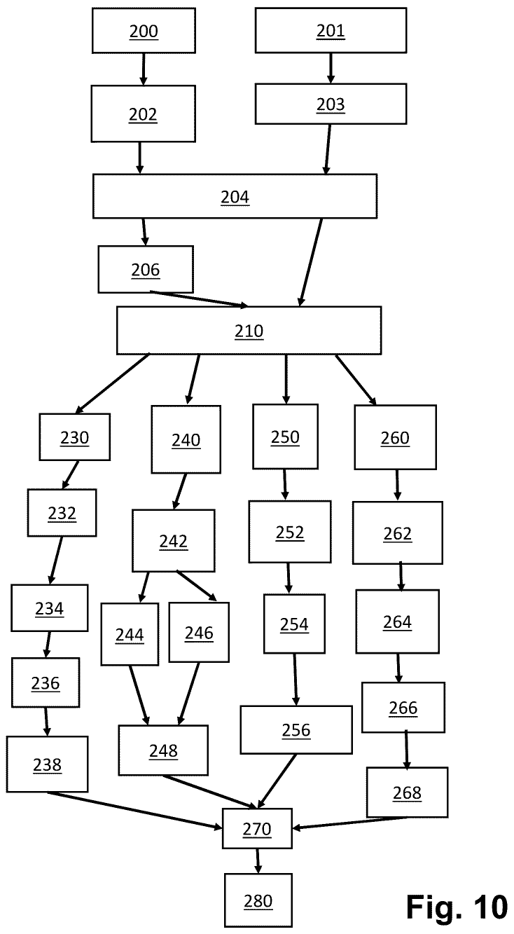

The analysis of the captured image data to determine the presence of a defect and/or to determine a quality score may be performed, for example, as follows. The procedure is illustrated using the flow chart shown in FIG. 10.

The starting point for the analysis of the captured image data is the four matrix-wise captured image data 200 of the top side of the object generated by illumination from different illumination directions and the line-wise captured image data 201 of the top side of the object using the pouch cell 101 as an example.

As described above, the perspective and/or the optical distortion of the matrix camera is first compensated in a step 202 for each of the four image data captured matrix-wise. Subsequently, the current position of the object during optical capture by the matrix camera is corrected in a step 204 (position correction), if necessary, i.e. rotated and/or shifted so that the image data takes up a predetermined position of the object in the field of view of the matrix camera. At the same time, the plurality of single, line-by-line captured image data 201 is merged by the data processing unit 70 in step 203 into a single image (data) and, if necessary, corrected for inconsistencies/overlaps during merging of the image of the top side of the object from the line-by-line captured image data, as described above. The merging comprises the positional juxtaposition of the line-by-line captured image data of the object, so that a matrix of image data (second overall matrix) is created. In other words, the second overall matrix contains the individually line-by-line determined image data for the entire top side of the object or for a predetermined section of this top side corresponding to the position at which the incident light of the line lighting unit was reflected on the top side of the object, and thus also contains an image of the top side of the object. Subsequently, this data is also corrected in step 204, e.g. with respect to its position and/or size of the matrix, as described above. The merged and corrected line-by-line captured image data forms the second overall matrix.

For the four matrix-wise captured, compensated and corrected image data, the determination of a maximum image, an absorption image and/or a topology image subsequently follows in step 206 of the top side of the object. The calculation from the four matrices of image data is described in detail above. The maximum image is also referred to as the first overall matrix.

Segmentation is now carried out in step 210. For segmentation, for example, layout recipes may be used to extract desired image data portions from the respective (corrected) image data matrix of the top side determined by matrix-wise capture or line-by-line capture.

In principle, when segmenting using a layout recipe, the layout recipe predefines a given portion of the object with regard to the field of view of the matrix camera. As the object is not always exactly in the specified ideal position when the image is captured by the matrix camera, but may be shifted/rotated by a few pixels, a position correction is carried out, for example, using specified fixed points of the object, i.e. a registration to the expected position is carried out, so that the first overall matrix (or correspondingly the n first overall matrices or the second overall matrix determined from the line-by-line observation) is adapted accordingly to the ideal position of the object. The aforementioned matrices with image data are rotated and/or shifted accordingly. Once this adaptation has been carried out, the desired image data portions may be reliably identified using the specified layout recipe and extracted accordingly.

For example, a first image data portion is extracted in the form of the upper surface section (image data from direct recording by the camera/matrix camera) 113, a second image data portion is extracted from the recording areas via the mirrors on the shorter side in the form of the two corner sections 125 and a further second image data portion is extracted in the form of the four terrace sections (image data from direct recording by the camera/matrix camera) 126, 127, 128, 129. The segmentation is performed with respect to the corrected and merged line-by-line captured image data (i.e. from the second overall matrix) as well as with respect to the matrix-by-matrix captured, compensated and corrected image data and the maximum image (first overall matrix) and/or the absorption image and/or the topology image. Subsequently, the image data portions obtained by segmentation are processed in parallel and finally fed to an overall evaluation of the object.

In step 230, the result of the segmentation is, for example, an image data portion of the upper surface in the maximum image, in the absorption image, in the topology image and in the second overall matrix, respectively. In step 232, the data processing unit 70 examines each of these image data portions with respect to each pixel to determine whether they exceed a predetermined threshold value. Such a threshold value may be 240 for the image data portion of the maximum image, 220 for the image data portion of the topology image, 203 for the image data portion of the absorption image and 120 for the image data portion of the second overall matrix. If the image data value of the respective pixel is at or above the respective threshold value, a defect is detected. Subsequently, in step 234, further properties of the detected defect are determined, for example its size (by analysing whether a defect was also detected in neighbouring pixels) in pixels, a histogram of the image data values in the area of the respective defect, and/or the shape and orientation of the defect. The defect type is then determined in step 236 using the properties of the defect found and any other defects found in the image data portion, wherein different images/matrices in relation to the same location of the image data portion may be considered for this purpose. For example, based on the absence of a defect at the location in the absorption image, based on the determined ratio of length to width in the absorption image being greater than 5 and based on an average value of an image data histogram along the defect in the topology image that is greater than 200, all together the defect type ‘scratch’ may be concluded. In step 238, the severity of the detected scratch defect is then determined, wherein the determination may, for example, be based on an assignment of the size of the scratch to severity classes. In this context, if the defect is smaller than 2 pixels, the scratch defect can be assigned a severity level of zero, if the defect is greater than or equal to 2 pixels and smaller than 4 pixels, the scratch defect can be assigned a severity level of 1, if the defect is greater than or equal to 4 pixels and smaller than 6 pixels, the scratch defect can be assigned a severity level of 2, and so on.

The result of the segmentation in step 240 are, for example, image data portions in the form of four “corner sections” (e.g. 128×128 pixels) from the maximum image determined in step 206, wherein the “corner sections” are obtained, for example, from the image data generated via the mirrors 67 on the short side of the pouch. A CNN algorithm with a binary classifier, as explained below, is now applied to each of these image data portions in step 242. As a result, the attribute ‘defective corner’ (step 244) or ‘intact corner’ (step 246) is determined for each corner image data portion and assigned to the respective corner in step 248.

The corner image data matrix of each corner section may be analysed using, e.g., a Convolutional Neural Network (CNN) algorithm that includes a binary classifier (classifier with two states, namely ‘intact corner’ and ‘defective corner’). The corner image data matrix is defined comparatively small (e.g. 128×128 pixels) and image data forming the corner image data matrix is only taken from the area of the respective corner of the housing. This CNN model was specially developed for this classification task with few classes and for matrices with few pixels. This CNN model comprises a compact structure that is, for example, more compact than conventional deep architectures. For example, it consists of three strands with different convolution sizes, which are merged later. This structure reduces the number of parameters to be trained so that the model has fewer features to learn. For this reason, it is ideal for binary or other low-dimensional classification. For the training and evaluation of the CNN model, a large and broad dataset containing matrices of corner structures and corresponding expected defects is used. It is compiled in relation to the respective object to be analysed and annotated by engineers. This dataset contains images of corners of the respective objects (i.e. of the pouch-cells to be inspected), which are divided into two classes: ‘defective’ and “intact”. The images were carefully selected and annotated to ensure that they cover a wide range of defects and variations in the battery corners. Training of the model was performed on the dataset, wherein the images in the dataset may be split into training sets and validation sets. For example, a ratio of 80% may be used for the training data and 20% for the validation data. In addition, a five-fold cross-validation may be performed to ensure that all images are present in the training data and in the validation data. The model consists of several convolutional layers, pooling layers and fully connected layers, which enable the model to extract important features in the images and recognise the subtle differences between defective and intact corners. The convolutional layers are used to train the trainable weights of the convolution operations, which are then used to recognise image features. These features are then aggregated with the pooling layers. Subsequently, the weights of the fully connected layers are iteratively trained to determine a probability for the associated class from the features. In addition, prior to the analysis with the CNN algorithm, all images/segments may be cut out in the same size as the corner image data matrices to be analysed (128×128 pixels) and oriented in such a way that they were caused to have the same orientation in order to enable a consistent view.

Results of the segmentation in step 250 are, for example, image data portions in the form of terrace portions (to the terraces 126, 127, 128, 129) from the maximum image determined in step 206, wherein the image data has been generated by direct capture by means of the matrix camera 40 from above. Now, the mask RCNN algorithm is applied to these terrace image data portions (described in more detail below, step 252). As a result, defects in the terrace image data portions of different defect types are recognised and provided with a bounding box (step 254). The severity of the respective defect is subsequently also determined in relation to the defects detected in the terrace image data portions, for example based on the detected defect type, the size of the bounding box, the shape of the bounding box, etc. (step 256).

In this process, each portion of the predetermined portions of the lateral surface sections extracted by segmentation (e.g. terrace sections of a pouch cell) is analysed using an object detection network based on the mask RCNN model. The algorithm recognises defects of a variety of different defect types (e.g. 6 different defect types such as protrusion/nose/prominence, indentation, fold, scratch, contamination, particle) and adds a corresponding bounding box to the data of the corresponding second image data portion in the area of the defect. To train the Mask-RCNN model as an algorithm, data representing a corresponding second image data portion is used, wherein the corresponding defects are annotated in these image data matrices and provided with a bounding box. The architecture of the Mask RCNN model was carefully selected. This model is a further development of the Faster R-CNN model and is able to generate bounding boxes and masks for defects in the specified areas. Rarely occurring defect types are artificially inserted into corresponding image data portions of the given areas to train the model. The performance of each model is evaluated using a separate validation dataset. For example, a validation data set with a ratio of 80% for the training data and 20% for the validation data may be used. This ensures that the model recognises defects efficiently and accurately and classifies them correctly.

The result of the segmentation is, for example, in step 260, image data portions in the form of the upper surface section 113, for example the maximum image and an image merged from the line-by-line capture, each one covering the upper surface section 113. These image data portions are divided into patches in step 262 and subsequently analysed in step 264 as described below using the pre-trained CNN algorithm ‘Wide ResNet-50’. As a result of this analysis an anomaly or anomalies may be detected in some patches. In step 266, the Mahalanobis distance to the normal distribution is determined for each patch in which an anomaly was detected and each detected anomaly is determined. From this, the severity of the anomaly and thus of the respective defect is determined in step 268.

When analysing the segmentation result in step 260, in one embodiment, the resolution in the predetermined (sub-)region may be reduced to a predetermined value (e.g. from 5120×2216 to 841×265 pixels) to speed up the process. The image is divided into several small patches (subregions) (step 262). Subsequently, a pre-trained CNN algorithm ‘Wide ResNet-50’ is used as the first NN algorithm to examine each patch to determine whether one or more predetermined features (defects/anomalies) are present in the respective patch. In ‘Wide ResNet-50’, the layers of the network are made ‘wider’ by increasing the number of channels in the convolutional layers. This CNN is able to recognise complex patterns and textures. It has also been observed that such wider CNNs are often better able to generalise, meaning that they may process new, unknown data more effectively. The method is also known as PaDiM (Patch Distribution Modelling Framework for Anomaly Detection and Localisation) and is an algorithm for the task of anomaly detection and localisation. This approach is particularly suitable for the detection of industrial defects, where the aim is to identify irregularities or deviations from the norm in visual data. PaDiM models the distribution of features in an image. Subsequently, the features extracted by the CNN are collected for each patch. For each patch, the Mahalanobis distance between the features of the patch and a normal distribution derived from the training data is calculated. This step determines how ‘abnormal’ or unusual each patch is compared to normal training data. The calculated Mahalanobis distance serves as the anomaly score, wherein a higher value indicates a greater deviation from normality. A threshold is set based on the anomaly score. Patches with a score that exceeds this threshold are considered abnormal. Anomalies are localised by marking the positions of the patches classified as abnormal in the image data portion, which enables the localisation of the anomalies in the respective image data portion.

The anomaly score is calculated separately for each patch by calculating the Mahalanobis distance of its features from the expected normal distribution, which is represented by the mean value and covariance matrix from the training data. A large Mahalanobis distance indicates that the features of the patch deviate strongly from the normal distribution, indicating a potential anomaly. Mathematically, the Mahalanobis distance D of a point x to a distribution with the mean value μ and the covariance matrix Σ is calculated as follows:

$$D ( x ) = \sqrt{{( x - μ )}^{T} {\sum }^{- 1} ( x - μ )}$$

D(x) refers to the Mahalanobis distance for the point.
x refers to the vector of observed values.
μ is the mean value vector based on the training data volume.
Σ refers to the covariance matrix of the training data.
Σ⁻¹ is the inverse of the covariance matrix.
T denotes the transposition of the vector.

For each patch, the anomaly score results in an assessment of the severity of the defect present in the respective patch.

In all of the above cases, the severity of the defect is expressed in terms of predetermined classes.

Subsequently, in step 270, the data processing unit 70 evaluates the quality of the pouch cell 111 as a whole based on all the defects determined in the four analysis strands, the respective defect type and the respective severity of the defect. It is being assessed whether the pouch cell 111 as a whole fulfils the specified quality requirements or not. In step 280, the result of the overall assessment is provided at an interface of the data processing unit, optionally together with a list of the determined defects and their characteristics. For example, a pouch cell with two defects of type ‘Dent’ of severity class 5 is judged to be sufficient for the quality requirements. In contrast, a pouch cell having a defect of the defect type ‘Dent’ of severity class 7, for example, may be classified as not meeting the quality requirements.

The above method may also be carried out analogously for the bottom side of the pouch cell.

As indicated above, the method according to the invention may be used to carry out an inspection of a three-dimensional object, e.g. a pouch cell, in a simple and fast manner, wherein the various properties of the sections of the object may be taken into account during the analysis.

1: A device for inspecting three-dimensional objects, wherein each object comprises a housing having a top side and a bottom side, wherein the top side of the housing is composed of at least one upper surface section and a plurality of lateral surface sections which run obliquely, in parallel or perpendicularly to the at least one upper surface section or form corner sections, wherein the bottom side of the housing is composed of at least one bottom surface section and a plurality of lateral surface sections that run obliquely, in parallel or perpendicularly to the at least one bottom surface section, or form corner sections, the device comprising:
a motion detection unit that captures motion data with respect to each object to be inspected, with regard to relative motion to a line lighting unit, “motion state,” and with regard to an arrangement in a predetermined position and over a predetermined time period with respect to an area lighting unit, “rest state,”
the line lighting unit for illuminating a line-shaped area of the top side of the object to be inspected,
the area lighting unit for illuminating the top side of the housing of the object to be inspected from above in its rest state,
if necessary, at least one first deflecting mirror arranged next to respectively one side of the housing in the rest state of the object,
a matrix camera arranged above the object to be inspected for capturing image data in a field of view, wherein the field of view is configured:
for line-by-line capturing of the line lighting unit's light reflected into the matrix camera from the line-shaped area of the top side in the motion state of the object to be inspected and
for the matrix-wise capturing of the area lighting unit's light reflected upwards from the top side in the rest state of the object to be inspected, optionally including the light reflected from the lateral surface sections, if applicable via the at least one first deflection mirror, into the matrix camera, and
a data processing unit, which is configured to receive and process the image data recorded by the matrix camera and the detected motion data, wherein the data processing unit assigns the image data captured line-by-line in the motion state and the image data captured matrix-wise in the rest state to the respective object to be inspected and determines from these image data the presence of a defect of at least one defect type and/or determines a quality score which allows an assessment of the quality of the object.

2: The device according to claim 1, wherein the line-shaped area which is illuminated extends over the entire length of the top side.

3: The device according to claim 1, wherein the matrix camera is configured to capture, in at least one of its captures of a detection sequence:
line-by-line the line lighting unit's light reflected from the line-shaped area of the top side in the motion state of a first object and
matrix-wise the light reflected upwards from the top side of the area lighting unit in the rest state of a second object, optionally the light reflected from the lateral surface sections of the second object, if applicable via the at least one first deflection mirror, into the matrix camera, wherein the second object is different from the first object.

4: The device according to claim 1, further comprising at least four first deflecting mirrors, wherein in the rest state of the object each first deflecting mirror is arranged next to a side of the housing, respectively.

5: The device according to claim 1, wherein the area lighting unit is configured to illuminate the top side of the object's housing in the rest state of the object to be inspected temporally in succession from at least two different directions from an oblique top side,
wherein the matrix camera is configured for temporally successive matrix-wise capture of the at least two image data for the illuminations of the at least two directions of the area lighting unit, and
wherein the data processing unit is correspondingly configured to receive and process the at least two image data captured matrix-wise, associates these image data with the respective object and uses these image data to determine the presence of a defect of at least one defect type and/or the quality score, which allows the quality of the object to be assessed.

6: The device according to claim 5, wherein the data processing unit uses a maximum image of the image data, which was determined from the at least two image data captured matrix-wise when illuminated from the at least two directions of the area lighting unit, to determine the presence of a defect of at least one defect type and/or the quality score.

7: The device according to claim 1, wherein the line lighting unit emits line-shaped high dynamic range (HDR) reflection bright field illumination.

8: The device according to claim 1, wherein the matrix camera is calibrated in such a way that image data processing by the data processing unit takes into account perspective and optical distortion contained in the image data captured matrix-wise.

9: The device according to claim 8, wherein the data processing unit is configured to determine at least one dimension of the object and/or at least one size of a detected defect after taking into account the perspective and the optical distortion.

10: A system comprising:
the device according to claim 1 and
a second device for inspecting three-dimensional objects, wherein the second device for inspecting three-dimensional objects is arranged downstream of the device in the direction of transport of the object to be inspected, wherein the bottom side of the object, which is located on top after the object has been turned over after the device, is inspected by the second device for inspecting three-dimensional objects.

11: A method for inspecting three-dimensional objects, wherein each object comprises a housing having a top side and a bottom side, wherein the top side of the housing is composed of at least one upper surface section and a plurality of lateral surface sections, which run obliquely, in parallel or perpendicularly to the at least one upper surface section or form corner sections, wherein the bottom side of the housing is composed of at least one lower surface section on the bottom side as well as a plurality of lateral surface sections which run obliquely, in parallel or perpendicularly to the at least one lower surface section or form corner sections,
wherein the method comprises the following steps:
detecting motion data with regard to a relative movement of each object to be inspected to a line lighting unit, “motion state,” and with regard to an arrangement of the respective object in a predetermined position and over a predetermined time period in relation to an area lighting unit, “rest state,” by a motion detection unit,
illuminating a line-shaped area of the top side of the object to be inspected by the line lighting unit,
illuminating the top side of the housing of the object to be inspected from above in its rest state by the area lighting unit,
capturing image data in a field of view by a matrix camera arranged above the rest state position of the object to be inspected, wherein the field of view is configured:
for line-by-line capturing of the line lighting unit's light reflected into the matrix camera by the line-shaped area of the top side in the motion state of the object to be inspected and
for matrix-wise capturing of the light reflected upwards from the top side of the area lighting unit in the rest state of the object to be inspected, optionally including the light reflected from the lateral surface sections of the object to be inspected, if applicable via at least one first deflecting mirror into the matrix camera,
receiving and processing the image data captured by the matrix camera and the detected motion data by a data processing unit, wherein the data processing unit assigns the image data captured line-by-line in the motion state and the image data captured matrix-wise in the rest state to the respective object to be inspected and determines from these image data the presence of a defect of at least one defect type and/or determines a quality score, which allows an assessment of the quality of the object.

12: The method according to claim 11, wherein the illuminated line-shaped area extends over the entire length of the top side and/or wherein at least four first deflecting mirrors are provided, wherein each deflecting mirror is arranged in the rest state of the object next to a respective side of the housing.

13: The method according to claim 11, wherein by capturing by the matrix camera, in at least in one of its captures of a detection sequence:
line-by-line, the line lighting unit's light reflected from the line-shaped area of the top side in the motion state of a first object and
matrix-wise the area lighting unit's light reflected upwards from the top side in the rest state of a second object, optionally the light reflected from the lateral surface sections of the second object, if applicable via the at least one first deflection mirror, into the matrix camera, wherein the second object is different from the first object.

14: The method according to claim 11, wherein the area lighting unit illuminates the top side of the housing of the object in the rest state of the object to be inspected temporally in succession from at least two different directions obliquely from above,
wherein the matrix camera correspondingly temporally successive captures matrix-wise these at least two image data of the illuminations from the at least two directions of the area lighting unit, and
wherein by the data processing unit the at least two image data captured matrix-wise are received and processed accordingly, these image data are assigned to the respective object and used to determine the presence of a defect of at least one defect type and/or the quality score.

15: The method according to claim 11, wherein the matrix camera is calibrated in such a way that the image data processing of the data processing unit takes into account perspective and optical distortion contained the image data captured matrix-wise.

16: The method according to claim 11, wherein the line lighting unit emits line-shaped high dynamic range (HDR) reflection bright field illumination.

17: The method according to claim 14, wherein the data processing unit uses a maximum image of the image data, which was determined from the at least two image data captured matrix-wise when illuminated from the at least two directions of the area lighting unit, to determine the presence of a defect of at least one defect type and/or the quality score.

18: The method according to claim 15, wherein, by the data processing unit, at least one dimension of the object and/or at least one size of a detected defect is determined after taking into account the perspective and the optical distortion.
